(19) United States
(12) Patent Application Publication
(10) Pub. No.: US 2002/0190621 A1
(43) Pub. Date: Dec. 19, 2002

(54) Headlamp and rear combination lamp for an automobile and a method of designing the same

(76) Inventors: Jung-Hyang Park, Taegu-City (KR); Tae-Yeung Kang, Taegu-City (KR)

Correspondence Address: HARNESS, DICKEY & PIERCE, P.L.C., P.O. BOX 828, BLOOMFIELD HILLS, MI, 48303, US

(21) Appl. No.: 09/880,181

(22) Filed: Jun. 13, 2001

(51) Int. Cl. H01J 61/40

(52) U.S. Cl. 313/113; 445/3

(57) ABSTRACT

A headlamp and a rear combination lamp for an automobile according to the present invention comprise a clear lens without a spread optic and a prism cut, and a reflector having a single surface without any discontinuity, in which the reflector is formed as a free form reflector by using an iterative routine of an automatic designing program for the headlamps and the rear combination lamps. Accordingly, the headlamp and the rear combination lamp can indicate a desired light distribution pattern without lens prism. Further, the headlamp and the rear combination lamp can conform to the laws and regulations connected with the light pattern and accede to a consumer's demand.

### BACKGROUND OF THE INVENTION

1. Field of the Invention

The present invention relates to a design of reflector optics with a smooth surface for automotive lamps, and more particularly to a headlamp and a rear combination lamp for an automobile capable of indicating a desired light distribution pattern without lens prism, which are capable of conforming to the laws and regulations connected with the light pattern and are capable of acceding to a consumer's demand, in which the headlamps and the rear combination lamps have a reflector and a clear lens without a spread optic and a prism cut, the reflector having a reflective surface which is formed as a single continuous surface without any discontinuity by using an iterative routine of an automatic designing program for the headlamps and the rear combination lamps. Further, the present invention relates to a method of designing the headlamp and the rear combination lamp of the automobile.

2. Description of the Related Art

Generally, a headlamp mounted to a front surface of an automobile illuminates via a light beam ahead of the automobile for comfortable driving during darkness. Accordingly, the headlamp must have high quality light performance to allow a driver of the automobile to easily recognize an obstacle in front of the automobile.

The headlight includes a bulb for illuminating a light beam, a reflector for reflecting the light beam illuminated from the bulb, and a lens for reflecting the light beam reflected from the reflector to conform with the laws and regulations for the light pattern. At this time, the reflector is disposed at the rear side of the bulb, and the lens is installed at a front surface of the headlamp.

The headlamp creates a certain light pattern through a parabolic reflector and an optic lens. A light beam emitted from a light source is reflected from the reflector. Thereafter, the light beam passes through the optic lens. The spread optic formed at the lens causes diffusion of the light beam. Alternatively, the prism cut formed at the lens causes convergence of the light beam. After passing through the optic lens, the light beam becomes a desired light pattern coinciding with the standard light pattern so that it conforms to the laws and regulations connected with the light pattern.

Furthermore, the rear combination lamp is disposed at the rear part of the automobile. The rear combination lamp has a function to indicate a driver's intention (for example, reduction of speed, stop the automobile, change of direction) in a forward automobile to other drivers of following automobiles. This rear combination lamp comprises all types of lamps, including two tail lamps, parking signal lamps, stop signal lamps, turn signal lamps, a backward movement alarm lamp, reflective lamps of the automobile rear part, a lamp for illuminating the license number plate, etc.

FIG.6 shows a conventional lamp including a parabolic reflector and an optic lens.

As shown in FIG. 6, a curved surface of the reflector in the lamp is formed as a parabola-shaped surface. Further, a plurality of optics are formed at the lens. When the light beam reflected from the reflective surface passes through the optics of the lens, it diffuses and becomes concentrated. However, this lamp creates a desired distribution of the light beam due to the use of optics in the lens. If the shape of lens becomes more aerodynamic, then it is difficult to control the light beam by only using the optics in the lens. Consequently, a loss of light beam increases significantly.

Accordingly, a variety of endeavors for solving these problems have been proposed. One approach is, the multi face reflector has been proposed.

As shown in FIG. 7, the multi face reflector consists of an optic reflector and a clear lens. The optic reflector has a plurality of optics at a surface thereof. Alternatively, the clear lens does not have any optics. Since a curved surface of the reflector consists of several divided surfaces, the light beam reflected from the curved surface of the reflector weakens due to the height difference of the divided surfaces. Consequently, glare is generated. Further, a consumer satisfaction in connection with this design of lamp is less.

Alternatively, a complex shape reflector including a free form reflector and an optic lens has been proposed. This complex shape reflector minimizes the number of optics to be formed at the surface thereof. While the above complex shape reflector has merits such that the processing of the reflective surface can be easily performed and a desired light pattern can be easily obtained, the aerodynamic stability deteriorates owing to the use of optic lens. Further, an aesthetic sense of the reflector is not good. In addition, it is difficult to satisfy the requirement for creating a desired light pattern.

### SUMMARY OF THE INVENTION

The present invention solves the foregoing problems. It is a first object of the present invention to provide a method of designing headlamps and rear combination lamps of an automobile capable of indicating a desired light distribution pattern without lens prism, which is capable of conforming to the laws and regulations connected with the light pattern and is capable of acceding to a consumer's demand. The headlamps and the rear combination lamps have a reflector and a clear lens therein, respectively. The reflector has a reflective surface which is formed as a single continuous surface without any discontinuity by using an iterative routine of an automatic designing program for the headlamps and the rear combination lamps. The clear lens is installed at the front side of the headlamps and the rear combination lamps, respectively. This clear lens does not have a spread optic or a prism cut.

In order to achieve the above first object, the present invention provides the automatic designing program comprising the steps of:

designing(S1) a desired light pattern;

designing(S2) an initial reflector shape;

determining(S3) an initial light pattern by defining the type of light source and by determining the position of the light source;

setting(S4) the changing direction of the light pattern by creating an algorithm for calculating the difference between the simulated light pattern and the desired light pattern;

changing(S5) little by little the control points of the reflective surface in order to reduce the difference between the simulated light pattern and the desired light pattern;

calculating(S6) the simulated light pattern of the reflector having a modified shape;

judging(S7) whether the difference between the simulated light pattern and the desired light pattern is eliminated or not; and

repeating(S8) the above steps (S4) through (S7) when the difference between the simulated light pattern and the desired light pattern is not eliminated.

It is a second object of the present invention to provide headlamps and rear combination lamps comprising a clear lens without a spread optic and a prism cut, and a reflector having a single surface without any discontinuity.

In the conventional headlamps and rear combination lamps, the concentration and the diffusion of the light beam are accomplished by using the optics in the lens and the divided surfaces in the multi face reflector. However, in the present invention, the concentration and the diffusion of the light beam are accomplished by only using the single free form surface of the reflector. In other words, in the present invention, the simple design of the headlamps and the rear combination lamps is capable of satisfying the requirement for creating an optimal light pattern by using the free form reflector.

### BRIEF DESCRIPTION OF THE DRAWINGS

The above object and other characteristics and advantages of the present invention will become more apparent by describing in detail preferred embodiments thereof with reference to the attached drawings, in which:

FIG. 1 is exploded perspective views of a reflector and a lens according to a preferred embodiment of the present invention;

FIG. 2 is a block diagram for showing a designing procedure of the reflector in accordance with an automatic designing program of headlamps and rear combination lamps according to the preferred embodiment of the present invention;

FIGS. 3A to 3C show vertical sectional curves and horizontal sectional curves of the reflector in accordance with the designing procedure of the reflector according to the preferred embodiment of the present invention and show light patterns illuminated on a screen;

FIG. 4 shows the light pattern illuminated on the screen which is attained at the final stage in the designing procedure of the reflector according to the preferred embodiment of the present invention;

FIG. 5 shows the light pattern illuminated on the road which is attained at the final stage in the designing procedure of the reflector according to the preferred embodiment of the present invention;

FIG. 6 is an exploded perspective view of a conventional lamp according to a prior art; and

FIG. 7 is an exploded perspective view of the multi face reflector and the lens according to the prior art.

### DETAILED DESCRIPTION OF THE INVENTION

Hereinafter, a method for designing headlamps and rear combination lamps of an automobile according to a preferred embodiment of the present invention will be explained in more detail with reference to the accompanying drawings.

In the preferred embodiment of the present invention, the position of a light source is determined on the basis of a desired light pattern, the type of light source, and an initial reflective surface in the automatic designing program of the headlamps and the rear combination lamps of the automobile. In the automatic designing program, a iterative work is performed to obtain an optimum reflective surface by changing the control points of the reflective surface until a simulated light pattern coincides with a desired light beam in accordance with the automatic designing program. At this time, simulating light pattern is performed at a position which is about 25 m away from the light source.

After defining the type of the light source and appointing the position of the light source, a value corresponding to the desired light beam is inputted, and the reflector is changed by setting a changing direction of the light beam. Then, the changing degree of the reflector and the simulated light beam reflected from the reflector are automatically calculated using an algorithm for the fast prediction of a light image. The optimal reflective surface can be obtained by repeatedly performing a process for calibrating the difference between the changed light pattern and the desired light pattern due to checking the changed light beam pattern.

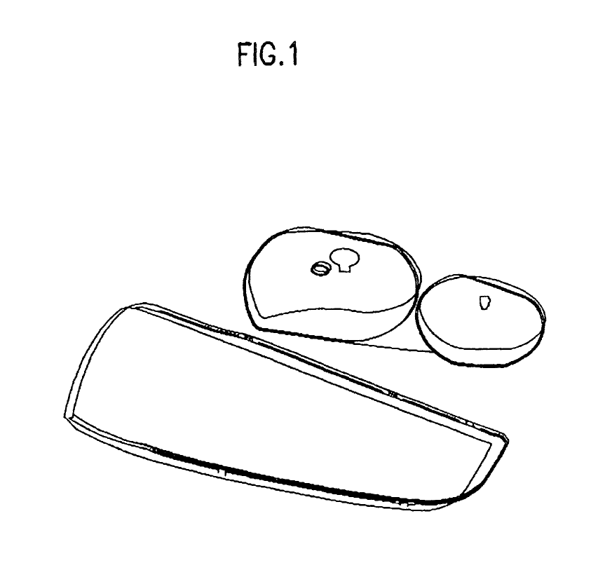

In the present invention, after setting the desired light pattern, the light source and the initial reflective surface, the shape of the reflective surface of the reflector is changed little by little until the light pattern reflected from the reflective surface indicates the desired light pattern. As a result of repeatedly performing this procedure, the whole surface of the reflector forms a single surface without any discontinuity as best seen in FIG. 1.

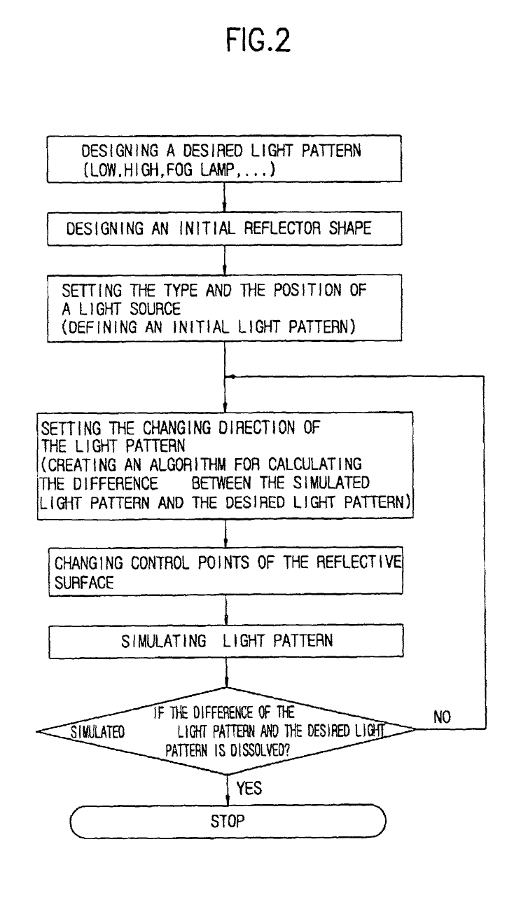

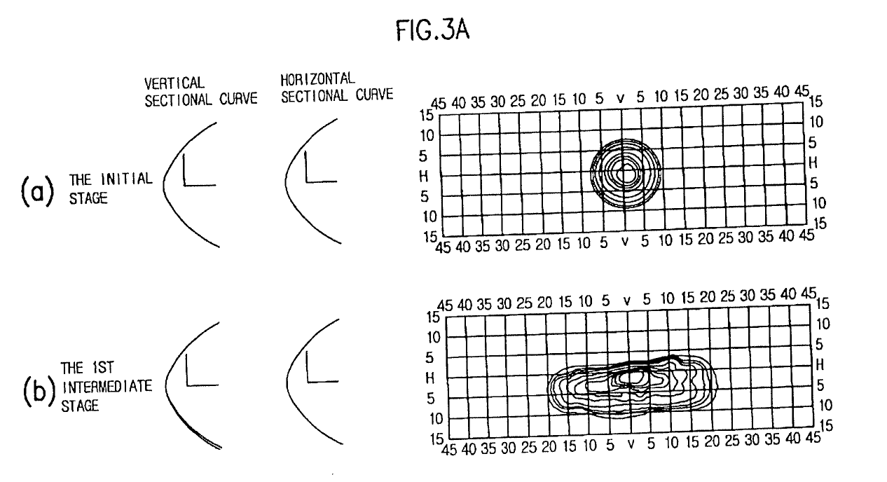

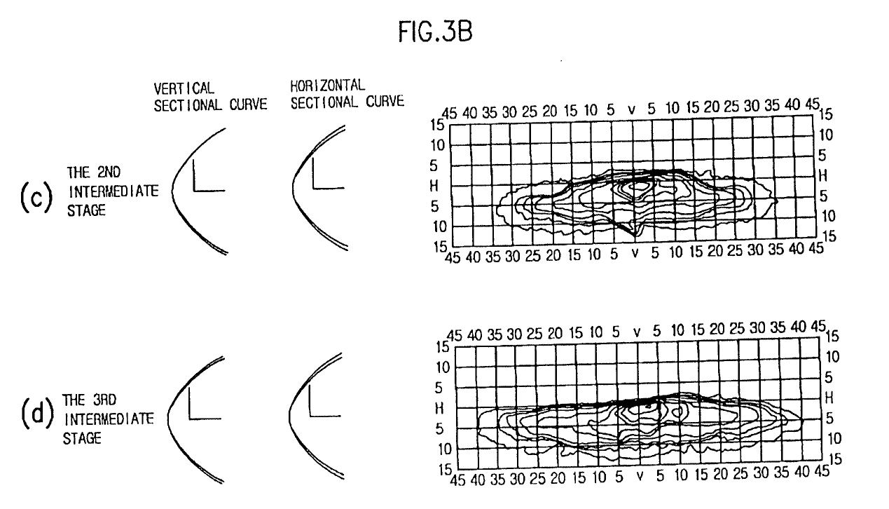

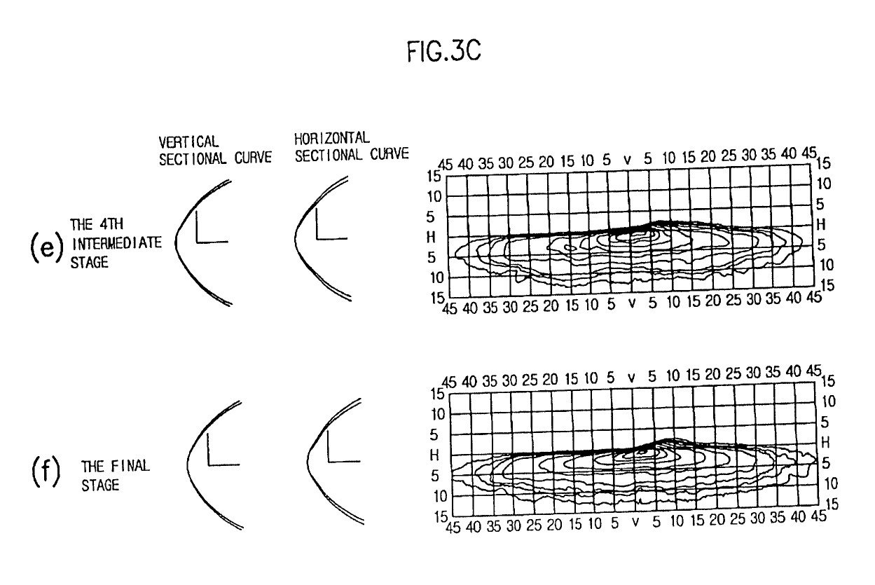

FIG. 2 is a block diagram for showing a designing procedure of the reflector in accordance with an automatic designing program of headlamps and rear combination lamps according to the preferred embodiment of the present invention. The designing procedure is illustrated in FIG. 3.

The reflective surface for allowing the simulated light pattern to coincide with the desired light pattern is obtained in the following stages.

1. Designing a Desired Light Pattern

In this stage, it is necessary to design an ideal light pattern of the headlamps such as high beam, low beam, fog beam, turn signal lamp, and to design an ideal light pattern of the rear combination lamps such as stop lamp, tail lamp, backup lamp, turn signal lamp.

The total quantity of the desired light pattern must coincide with the size of the present reflective surface because the quantity of the light pattern provided by the reflective surface depends on the size of the reflective surface. Further, the desired light beam must be designed to conform to the laws and regulations connected with the light pattern and to accede to a consumer's demand.

2. Designing an Initial Reflector Shape

Although there are many methods for expressing a free curved surface, an initial reflective surface of the initial reflector is designed by using the mathematical modeling for the definition of the reflector shape. At this time, the initial reflective surface is defined by minimizing the number of control points.

3. Defining the Initial Light Pattern

Since the light pattern is changed according to the position of the light source at the initial reflective surface, the initial light pattern is determined by defining the type of light source and by determining the position of the light source in order to obtain Hotzone or the spread of the initial light pattern.

4. Setting the Changing Direction of the Light Pattern

The difference between the simulated light pattern and the desired light pattern is calibrated on the basis of the data obtained as a result of repeatedly performing an iterative routine of the automatic designing program for the headlamps and the rear combination lamps. In other words, the difference between the simulated light pattern and the desired light pattern may be eliminated by changing the control points of the reflective surface.

Since the light pattern of the reflective surface is changed in accordance with a certain algorithm for calculating the difference between the simulated light pattern and the desired light pattern, an optimal algorithm must be created through continuously certifying the changing process of the light pattern.

5. Changing Control Points of the Reflective Surface

The expression for a free form surface according to the number of the control points of the reflective surface is restricted. When the difference between the simulated light pattern and the light pattern is not eliminated any more, it is required to increase the number of control points of the reflective surface and to change the reflective surface.

6. Simulating Light Pattern

In order to judge whether the reflector shape can provide the desired light pattern or not, it is required to simulate light pattern.

7. Judging Whether the Reflector Shape can Provide the Desired Light Pattern

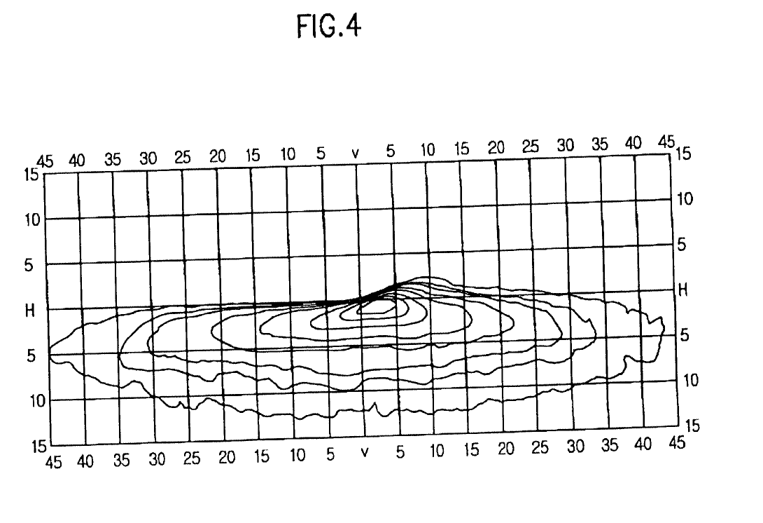

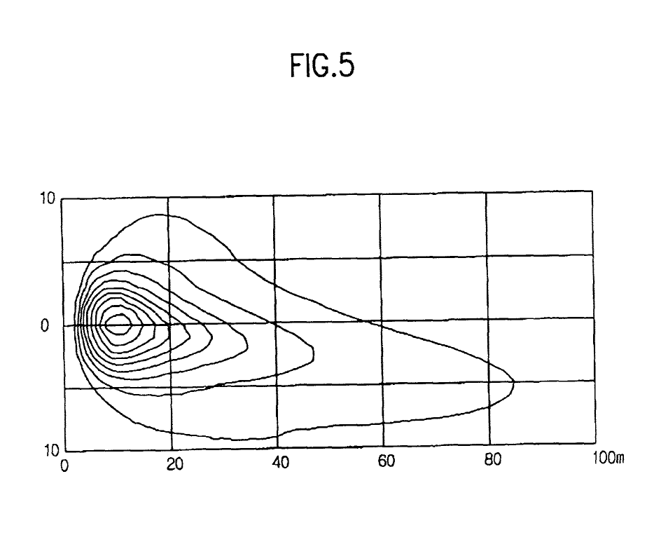

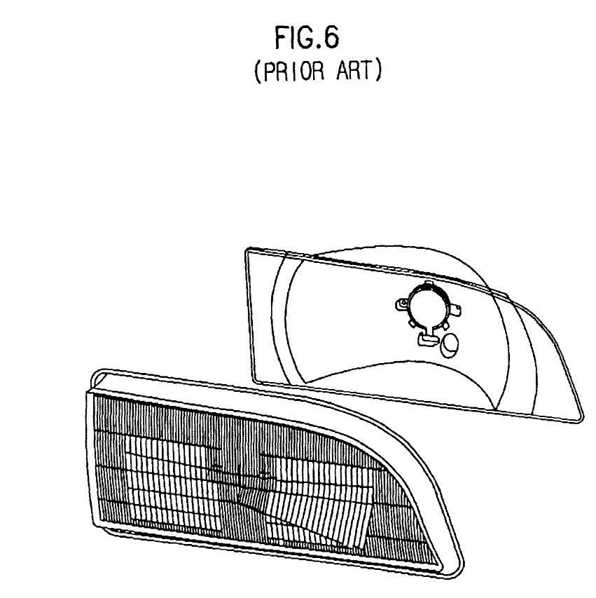

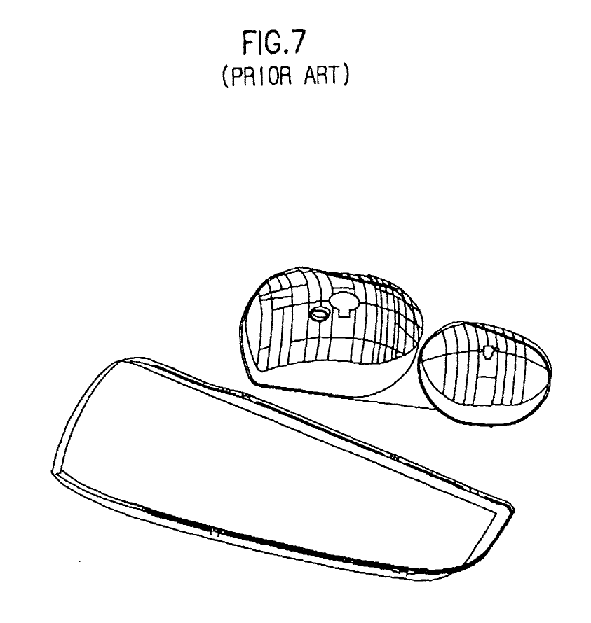

If the simulated light pattern coincides with the desired light pattern, the designing work is completed. As a result, the final reflective surface of the reflector is obtained. If the simulated light pattern does not coincide with the desired light pattern, it is necessary to return to step 4 and repeatedly perform the steps 4 through 7. Due to the repeated performance of this procedure, the difference between the simulated light pattern and the desired light pattern may be eliminated little by little. Consequently, it is possible to obtain the reflector having the light pattern corresponding to the desired light pattern as shown in FIG. 3(the final step 5). Further, it is possible to obtain the light pattern which is capable of conforming to the laws and regulations connected with the light pattern as shown in FIGS. 4 and 5.

FIGS. 3A to 3C show vertical sectional curves and horizontal sectional curves of the reflector in accordance with the designing procedure of the reflector according to the preferred embodiment of the present invention and show light patterns illuminated on a screen. As shown in FIGS. 3A to 3C, when the iterative routine of the automatic designing program for the headlamps and the rear combination lamps is repeatedly performed, the light patterns illuminated on the screen change little by little due to the change of the reflective surface in the reflector. The light pattern in the final stage in FIG. 3C coincides with the light pattern as shown in FIG. 4.

In FIGS. 3A-3C and 4, the numerals illustrated at the upper side and the lower side of the screen represent the vertical angles in units of 5 degrees. The numerals illustrated at the right side and the left side on the screen represent the horizontal angles in units of 5 degrees.

Since the all clear reflector designed and manufactured by the present invention has the reflective surface formed as one free form reflector shown in FIG. 1, it can provide for the European passing beam pattern and the USA lower beam pattern without the use of outer shielding elements. Consequently, the all clear reflector can provide a sufficiently good light quality. Since the clear lens of the all clear reflector has the single surface without any discontinuity, it is easy to process the clear lens and manufacture it.

If the lens has a large inclined angle owing to the design or the mounting structure of the automobile and has the optic, efficiency of the light pattern deteriorates. Since the reflector according to the present invention employs the clear lens, the headlamps and the rear combination lamps can be easily designed to create the best quality light pattern. Since the diffusion and the distribution of the light are controlled at the reflector, it is possible to provide a sufficiently good light quality. Because the whole surface of the reflector is formed as a single surface without any discontinuity, loss of light is minimal and the productivity of the reflector is quite enhanced.

As described above, in the present invention, the whole surface of the reflector for the headlamp and the rear combination lamp is designed as a single surface by using the Iterative Routine of the automatic designing program. Accordingly, it is possible to obtain the optimum reflective surface without any discontinuity in the lens and in the reflector. As a result, the performance for indicating the desired light pattern is quite enhanced about 35% compared with the conventional lamp.

Further, it is possible to reduce the size of the reflective surface. Because designing work can be freely performed, the exterior appearance of the headlamp and the rear combination lamp is good. Since the reflector is formed as a single free form reflector without any discontinuity and provides for the European passing beam pattern and the USA lower beam pattern, the reflector can provide a sufficiently good light quality. Since the lens disposed at the front surface of the reflector comprises a clear lens, the reflector is adapted to be installed in an aerodynamic structure.

In addition, since the diffusion and the convergence of the light are controlled at the reflector and the reflector employs the clear lens, the reflector can provide a sufficiently good light quality and a designer can increase the order of continuity of the reflector without any restriction. Since the whole surface of the reflector is a single surface without any discontinuity, it is possible to eliminate the nuisance of stray light caused by the step difference between individual segments of the reflector, and the manufacturing cost of the headlamp and the rear combination lamp can be reduced.

While the present invention has been particularly shown and described with reference to particular embodiments thereof, it will be understood by those skilled in the art that various changes in form and details may be effected therein without departing from the spirit and scope of the invention as defined by the appended claims.

What is claimed is:

1. A method of designing headlamps and rear combination lamps of an automobile by using an iterative routine of an automatic designing program for the headlamps and the rear combination lamps, wherein the headlamps and the rear combination lamps have a reflector and a clear lens therein, and a reflective surface of the reflector is formed as a single continuous surface without any discontinuity.

2. The method as in claim 1, wherein the automatic designing program comprises the steps of: designing(S1) a desired light pattern;
designing(S2) an initial reflector shape;
determining(S3) an initial light pattern by defining the type of light source and by determining the position of the light source;
setting(S4) the changing direction of the light pattern by creating an algorithm for calculating the difference between the simulated light pattern and the desired light pattern;
changing (S5) little by little the control points of the reflective surface in order to reduce the difference between the simulated light pattern and the desired light pattern;
calculating(S6) the simulated light pattern of the reflector having a modified shape;
judging(S7) whether the difference between the simulated light pattern and the desired light pattern is dissolved or not; and
repeating(S8) the above steps (S4) through (S7) when the difference between the simulated light pattern and the desired light pattern is not dissolved.

3. The method as in claim 2, wherein in the step(S1), because a quantity of light beam permitted by a reflective surface is changed according to the size of the reflector, the desired light pattern of the reflector is designed to accomplish the state that the total quantity of the desired light pattern should coincide with the size of the reflective surface, and is designed to conform to the laws and regulations connected with the light pattern and to accede to a consumer's demand.

4. The method as in claim 2, wherein in the step(S2), the initial reflector shape is designed by using a formula for expressing a free form surface with the aid of the minimized control points, wherein in the step(S3), because the initial light pattern is changed according to the position of the light source at the initial reflective surface, the initial light pattern is determined to accomplish the state that the Hotzone or the spread of the initial light pattern should be secured by defining the type of light source and by determining the position of the light source.

5. The method as in claim 2, wherein in the step(S4), the difference between the simulated light pattern and the desired light pattern is reduced by moving one by one the control points of the reflective surface through the iterative routine of the automatic designing program for the headlamps and the rear combination lamps of the automobile; the best quality light pattern is created and the design of the headlamps and the rear combination lamps is improved by continuously certifying the design procedure of the light pattern and by applying the algorithm for calculating the difference between the simulated light pattern and the desired light pattern.

6. The method as in claim 2, wherein in the step(S5), because the control of a free form surface depends upon the number of the control points in the reflective surface, the reflective surface should be modified by increasing the number of the control points in the reflective surface when the improvement of the light pattern by using the algorithm is impossible, and the final reflective surface of the reflector is obtained by repeatedly performing this procedure until the difference between the simulated light pattern and the desired light pattern is dissolved.

7. Headlamps and rear combination lamps comprising a clear lens without a spread optic and a prism cut, and a reflector having a single surface without any discontinuity, whereby the headlamps and rear combination lamps represent a light distribution pattern which coincides with a desired light pattern, and the headlamps and rear combination lamps conform to the laws and regulations connected with the light pattern and accede to a consumer's demand.
